(19) United States
(12) Patent Application Publication
(10) Pub. No.: US 2003/0117246 A1
(43) Pub. Date: Jun. 26, 2003

(54) Power switch with a double breaking contact arrangement

(76) Inventors: Tudor Baiatu, Brugg (CH); Elio Iacovino, Monza (IT); Manfred Stania, Greppen (CH); Willy Schwarz, Unterstammheim (CH); Werner Balsiger, Winterthur (CH)

Correspondence Address: BURNS DOANE SWECKER & MATHIS L L P, POST OFFICE BOX 1404, ALEXANDRIA, VA, 22313-1404, US

(21) Appl. No.: 10/203,904

(22) PCT Filed: Dec. 20, 2001
(86) PCT No.: PCT/CH01/00735

(30) Foreign Application Priority Data
Dec. 27, 2000 (EP) 00811248.4

(51) Int. Cl. H01H 75/00

(52) U.S. Cl. 335/16

(57) ABSTRACT

The power switch has a current flow path (7) with two supply terminals (1, 2) and a double breaking contact arrangement. The contact arrangement includes two series connected contact systems (10, 15), in which the current flow path extends in two sections guided parallel to one another. Said sections are formed by an arc (21, 22) during a switching operation. The contact parts (11, 12) of both contact systems are connected to one another and to both supply terminals (1, 2) in such a way that the current in both sections has the same direction. As a result, both arcs (21, 22) attract each other and displacement of the arcs relative to one another is prevented. Both arcs run synchronously into the arc extinction chamber (28, 29) with great reliability and are extinguished therein practically at the same time. The power switch is characterized by high cutout capability.

### TECHNICAL FIELD

The invention is based on a circuit breaker according to the precharacterizing clause of Patent claim 1. A switch such as this has a current path with two power connections and with a double-interrupting contact arrangement. The contact arrangement contains two series-connected contact systems, each having two contacts which move relative to one another. In this contact arrangement, the current path runs in two sections in parallel with one another. During a switching process, these sections are each formed by a switching arc which burns between the contacts. The switch may be used as a miniature circuit breaker in low-voltage distribution systems and is distinguished by a high disconnection rating and by a rapid response while having small dimensions.

### PRIOR ART

A switch of the abovementioned type is described, for example, in CH 543 174 A and in EP 619 592 A, as well. The described switch has a cuboid housing in which, in addition to a double-interrupting contact arrangement, two connecting terminals and a tripping mechanism with a drive and a release are also accommodated. The contact arrangement contains two contact systems which are arranged side by side alongside one another and are connected in series in a current path of the switch running between the two connecting terminals. The contact systems each contain a stationary contact and a moving contact. The moving contacts are mounted on a link contact support. The current path in both contact systems has two sections in which the current flows in the opposite direction sense. During a switching process, two switching arcs are thus formed through which the switching current flows in opposite senses, and which repel one another. If the two arcs do not move at the same speed, then the slower arc is repelled by the faster moving arc and may be prevented from reaching the arc splitter plates which assist quenching of the arc.

### DESCRIPTION OF THE INVENTION

The invention, as it is specified in the patent claims, is based on the object of developing the circuit breaker of the type mentioned initially such that, while retaining its dimensions, it can also disconnect large short-circuit currents with a high level of reliability.

In the circuit breaker according to the invention, the contacts of the two contact systems are connected to one another and to the two power connections such that the current has the same direction sense in both contact systems. This means that, during disconnection, the disconnection current flows in the same sense through the switching arcs formed in both contact systems. The two switching arcs thus no longer repel one another, but attract one another. This avoids the switching arcs moving relative to one another. The two arcs now enter the arcing chambers synchronously with a high degree of reliability, where they are quenched virtually at the same time. The circuit breaker according to the invention is thus distinguished by a high switching capacity.

One development of the switch according to the invention, in which the contact systems each have one of two arcing chambers which are arranged side by side with respect to one another, is distinguished by particularly low susceptibility to wear, if the moving contacts of the two contact systems are each arranged on one of the two arms of a contact link, which is in the form of a two-armed lever and can rotate, if the two stationary contacts of the contact systems are each arranged electrically conductively on a first of two arc guide rails of the arcing chambers, and if the two second arc guide rails of the two arcing chambers are electrically conductively connected to one another via a guide rail connection. This is primarily due to the fact that the guide rail connection may be formed by a robust busbar. In contrast to a flexible power connection, for example in the form of a braid, busbars such as these are subject to virtually no wear even after a large number of switching operations while, at the same time, they also have only a low electrical resistance. A switch developed in this way according to the invention is thus distinguished not only by a high switching capacity and a long life, but also by a minimal power loss and little heating.

The contact link should preferably be in the form of a U, with the rotation axis of the contact link being located in the base of the U. Furthermore, at the same time, the two moving contacts should be arranged at the free ends of the limbs of the U, and a section of the current path through which the current flows in the opposite sense should be provided parallel to each of the two limbs. This results in well-formed current loops in the current path. When the switch opens, a particularly strong electrodynamic force is then exerted on two switching arcs, which are initially based on the separating contacts and then commutate onto the arc guide rails.

Depending on the space required and the requirement for the switch, it is advantageous to route the guide rail connection around the contact link or around arc splitter stacks of the two arcing chambers. The two power connections at the ends of the two first arc guide rails, on which the stationary contacts are arranged, can also be routed in a corresponding manner, or one of the two power connections can be connected to one end of one of the two first arc guide rails, which engages over an arc splitter stack of one of the two arcing chambers.

If it is intended to avoid having a contact link in the form of a two-armed lever and for the movement of the moving contacts to be achieved by means of a tilting movement, then it is recommended, in a further embodiment of the switch according to the invention, that an intermediate conductor section be provided in the current path, and that this intermediate conductor section be connected between a moving contact of the first of the two contact systems and a stationary contact in the second contact system. Flexible electrical conductor sections, in particular in the form of braids, are then generally installed in the current path and compensate for any local position change of the moving contacts caused by the tilting movement.

It is recommended that the intermediate conductor section be arranged predominantly in the centre between the two contact systems. This results in the switch having a largely symmetrical design. Electrodynamic forces caused by asymmetries in the current path are largely avoided.

For reasons associated with the switch having a space-saving design according to the invention, it is advantageous to design the intermediate conductor section such that it is angled. The one limb of the angle can then be rigidly connected to a contact support of a stationary contact or, alternatively, can be connected via a flexible conductor section to a contact support of a moving contact of one of the contact systems, while the other limb of the angle is connected to a current sensor. If the current sensor is in the form of a bimetallic strip, then one end of the bimetallic strip can be connected to the limb end, and the bimetallic strip can be arranged in a particularly space-saving manner parallel to that limb.

If the switch according to the invention has two arc guide rails which are connected to the two contacts of each contact system and interact with the arcing chamber, then a switch current sensor which responds to short-circuit currents and/or overcurrents can be removed from the effect of the disconnection current during a disconnection process, if this current sensor is connected in parallel with an isolation gap which is formed by the two arc guide rails. If the switch according to the invention contains two current sensors, one of which responds to overcurrent while the other responds to short-circuit current, then both can be removed from the effect of the disconnection current during the disconnection phase by connecting a series circuit formed by the two current sensors in parallel with the isolation gap.

The switch according to the invention has a better current-limiting effect if the current sensor is connected in the current path in series with the isolation gap. The impedance of the current sensor, which is preferably in the form of a bimetallic element, is then in series with the switching arcs and then reduces the load on the switching arcs, limiting the current. If the switch according to the invention contains two current sensors, then particularly good current limiting is achieved if a series circuit comprising the two current sensors is connected in the current path in series with the isolation gap.

If one of these two current sensors is connected in parallel with the isolation gap, then this results in a switch with less current-limiting effect but with improved protection for this current sensor against an excessive current load.

### BRIEF DESCRIPTION OF THE DRAWINGS

Preferred exemplary embodiments of the invention and the further advantages which can be achieved by them will be explained in more detail in the following text with reference to drawings, in which:

FIG. 1 shows an equivalent circuit of one current path in a circuit breaker according to the prior art with a double-interrupting contact arrangement,

FIGS. 2 to 6 show equivalent circuits of the current paths of embodiments of the circuit breaker according to the invention,

FIG. 7 shows a perspective view of an embodiment of the circuit breaker according to the invention which is in the form of a structure and is illustrated in FIG. 2,

FIG. 8 shows a perspective view of an embodiment of the circuit breaker according to the invention which is in the form of a structure, in the connected state, in which two moving contacts of a double-interrupting contact arrangement are arranged on a contact link which is in the form of a two-armed lever,

FIG. 9 shows a perspective view of the circuit breaker shown in FIG. 8, during disconnection,

FIG. 10 shows a view of the circuit breaker shown in FIG. 8, in the direction of an arrow X,

FIG. 11 shows a view of the circuit breaker shown in FIG. 8, in the direction of an arrow XI,

FIG. 12 shows a perspective view of a modified first embodiment of the circuit breaker shown in FIGS. 8 to 11, during disconnection,

FIG. 13 shows a view of the circuit breaker shown in FIG. 12, in the direction of an arrow XIII,

FIG. 14 shows a view of the circuit breaker shown in FIG. 12, in the direction of an arrow XIV,

FIG. 15 shows a plan view of the contact link of the circuit breaker shown in FIG. 12, in the direction of an arrow XV,

FIG. 16 shows a perspective view of a modified second embodiment of the circuit breaker shown in FIGS. 8 to 11, during disconnection, and

FIG. 17 shows a perspective view of a modified third embodiment of the circuit breaker shown in FIGS. 8 to 11, during disconnection.

### WAYS TO IMPLEMENT THE INVENTION

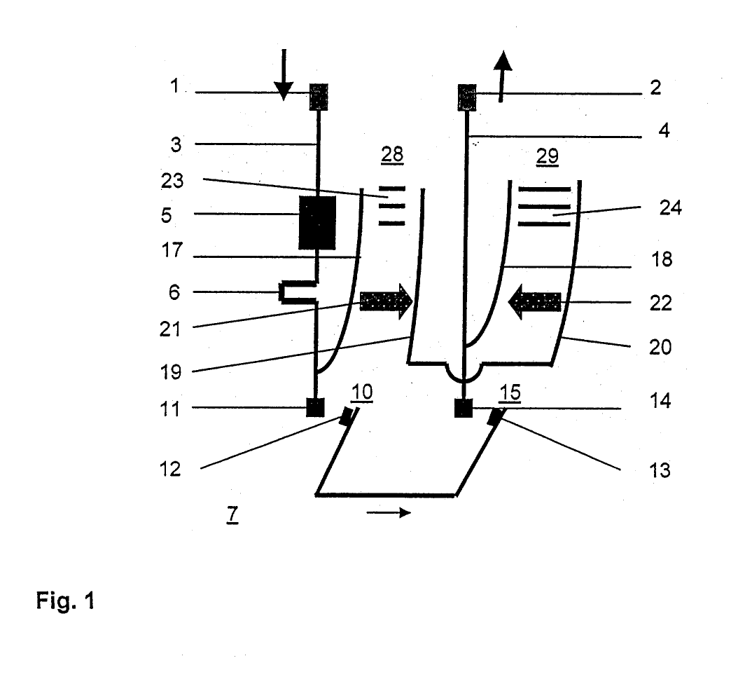

Identical reference symbols also denote parts having the same effect in all the figures. The equivalent circuits which can be seen in FIGS. 1 to 6 each contain a current path 7 of a circuit breaker running between two power connections 1, 2. In all the equivalent circuits, this current path in each case has an electrical conductor section 3 or 4, respectively, connected to the respective power connection 1 or 2. In the equivalent circuits shown in FIGS. 1, 2 and 4, the electrical conductor section 3 is in each case connected to a short-circuit current release 5, for example to a coil of an impact armature or to some other magnetic release. The short-circuit current release 5 is part of a tripping apparatus, which is not illustrated, for operating a switch contact arrangement containing two contact systems 10, 15.

In the equivalent circuit shown in FIG. 1, the short-circuit current release 5 is itself connected to a stationary contact 11 in the contact system 10 via an overcurrent release 6, which may be in the form of a bimetallic strip or some other thermal release, but possibly also in the form of a magnetic release such as a current transformer, and is likewise part of the tripping apparatus which is not illustrated. A moving contact 12 of the contact system 10 and a moving contact 13 of the contact system 15, which is connected in the current path 3 in series with the contact system 10, are arranged on a contact link, which is not shown. A stationary contact 14 in the contact system 15 is connected to the electrical conductor 4.

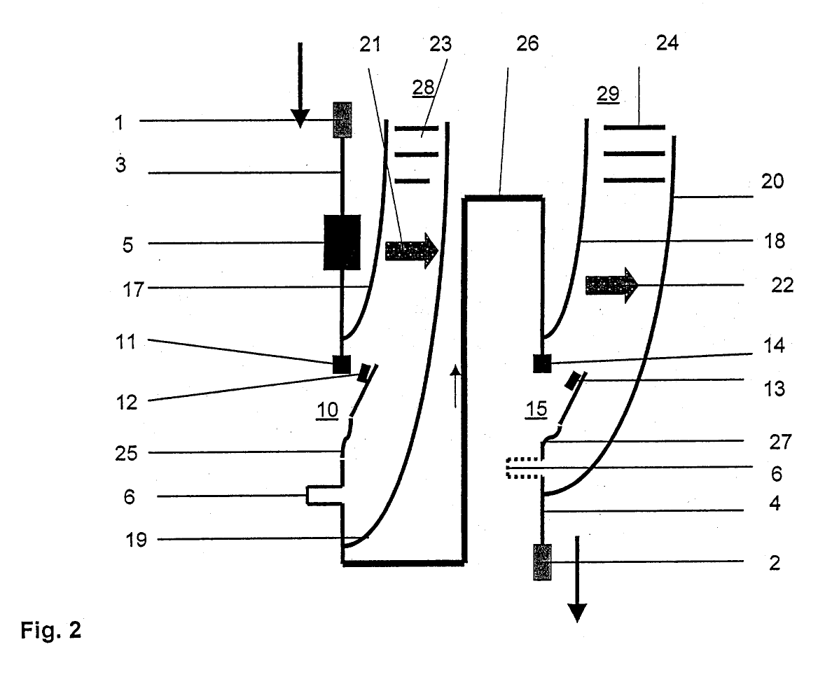

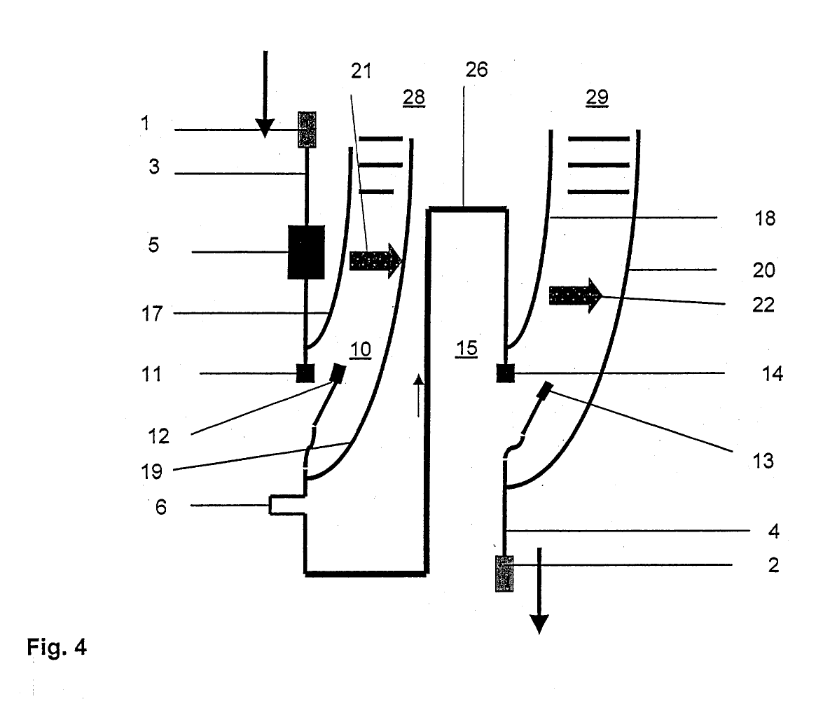

In the equivalent circuits shown in FIGS. 2 and 4, the short-circuit current release 5 is in each case directly connected to the stationary contact 11 in the contact system 10. The moving contact 12 in the contact system 10 is in each case connected to the overcurrent release 6 via a flexible electrical conductor section 25, for example a braid, and the overcurrent release 6 is itself in each case connected via an intermediate conductor section 26 to the stationary contact 14 in the contact system 15. The moving contact 13 in the contact system 15 is in each case connected to the electrical conductor section 4 via a flexible electrical conductor section 27, for example a braid.

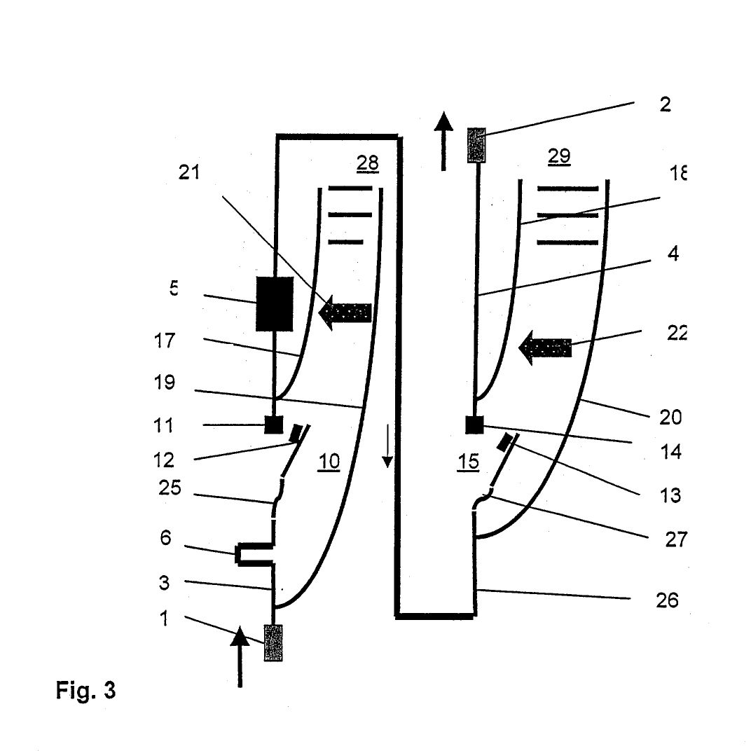

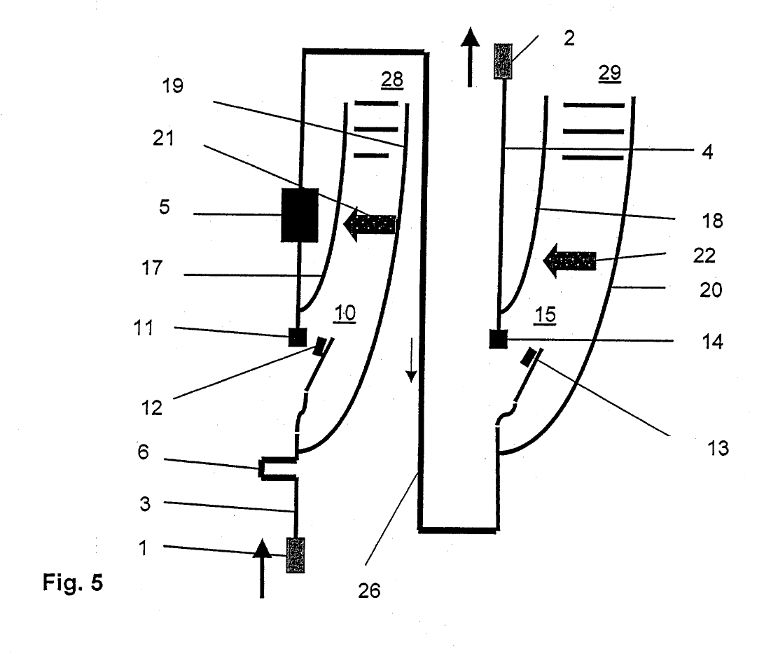

In the equivalent circuits shown in FIGS. 3 and 5, the electrical conductor section 3 is in each case connected to the moving contact 12 in the contact system 10 via the overcurrent release 6 and the flexible electrical conductor section 25. The stationary contact 11 in the contact system 10 is connected via the short-circuit current release 5 to the intermediate conductor section 26, which is itself connected to the moving contact 13 in the contact system 15 via the flexible electrical conductor section 27. The stationary contact 14 in the contact system 15 is connected to the electrical conductor section 4.

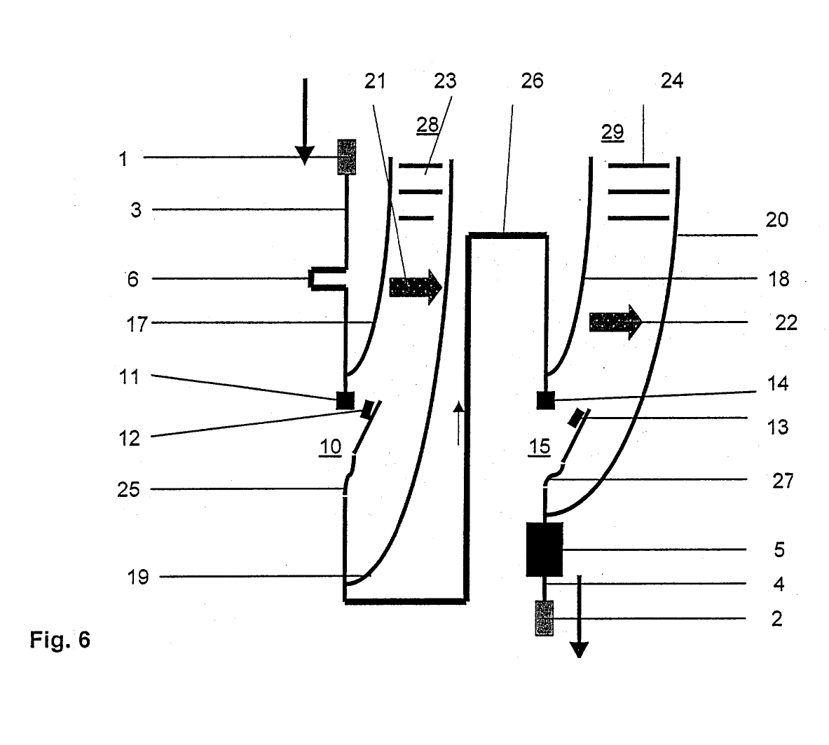

In the equivalent circuit shown in FIG. 6, the electrical conductor section 3 is connected to the stationary contact 11 in the contact system 10 via the overcurrent release 6. The moving contact 12 in this contact system is connected to the stationary contact 14 in the contact system 15 via the flexible conductor section 25 and the intermediate conductor section 26. The moving contact 13 in this contact system is connected to the electrical conductor section 4 via the flexible electrical conductor section 27 and the short-circuit current release 5.

In all the equivalent circuits, the arc guide rail 17 or 18, respectively, is connected to a contact support (which is not shown) of the respective stationary contact 11 or 14.

In the equivalent circuit of the switch as shown in FIG. 1, which is regarded as prior art, the moving contacts 12 and 13, respectively, interact with a respective arc guide rail 19 or 20. The arc guide rails 17, 19 and 18, 20 in each case carry switching arcs 21, 22, which are formed in the contact systems 10, 15 during a disconnection process, to a respective arc splitter stack 23 or 24 in a respective arcing chamber 28 or 29.

In the equivalent circuit shown in FIG. 2, the arc guide rail 19 is connected to the junction point of the overcurrent release 6 and of the intermediate conductor section 26, and the arc guide rail 20 is connected to the electrical conductor section 4. Alternatively, the overcurrent release can be connected in the current path between the junction point of the arc guide rail 20 and the conductor section 4 and the flexible electrical conductor section 27, as can be seen from the overcurrent release 6, which is illustrated by dashed lines, in FIG. 2. In the equivalent circuit shown in FIG. 3, the arc guide rail 19 is connected to the electrical conductor section 3, and the arc guide rail 20 is connected to the junction point of the intermediate conductor section 26 and the flexible electrical conductor section 27. These three equivalent circuits have the common feature that the overcurrent release 6 is connected in parallel with an isolation gap which is formed by the arc guide rails 17 and 19, or 18 and 20, and is bridged by the respective arc 21 or 22.

In the equivalent circuits shown in FIGS. 4 and 5, the arc guide rail 19 is in each case connected to the junction point of the overcurrent release 6 and the flexible electrical conductor section 25. In the equivalent circuit shown in FIG. 4, the arc guide rail 20 is connected to the electrical conductor section 4, and in the equivalent circuit shown in FIG. 5 it is connected to the intermediate conductor section 26. In the equivalent circuit shown in FIG. 6, the arc guide rail 19 is connected to the junction point of the flexible electrical conductor section 25 and the intermediate conductor section 26, and the arc guide rail 20 is connected to the junction point of the flexible electrical conductor section 27 and short-circuit current release 5. These three equivalent circuits have the common feature that the short-circuit current release 5 and the overcurrent release 6 are connected in the current path in series with the isolation gap which is formed by the arc guide rails 17 and 19 and is bridged by the arc 21.

In all the switches which are represented by the equivalent circuits 1 to 6, the respective arcing chamber 28 and 29, which contain the respective arc splitter stack 23 or 24 and at least sections of the arc guide rails 17, 19 or 18, 20 are arranged adjacent, alongside one another. The electromagnetic fields which are formed by the arcs 21 and 22 thus influence one another.

In the circuit breaker according to the prior art which is illustrated by the equivalent circuit shown in FIG. 1, the current to be disconnected—as indicated by arrows—flows from the power connection 1 via the electrical conductor section 3, the short-circuit current release 5, the overcurrent release 6, the contact systems 10 and 15 and the electrical conductor section 4 to the power connection 2. During disconnection, two arcs 21 and 22 are formed, which commutate from the contacts 11, 12 and 13, 14 onto the arc guide rails 17, 19 and 18, 20. As can be seen, the current to be disconnected flows in opposite senses through the arcs in this switch. Since the arcing chambers of both contact systems 10 and 15 are adjacent alongside one another, the arcs repel one another, owing to the electrodynamic forces. If one of the two arcs, for example the arc 21, is somewhat weaker than the other, for example the arc 22, then the stronger arc 22 decelerates the movement of the weaker arc 21 on the arc guide rails 17, 19, or even prevents it from entering the arc splitter stack 23. This considerably limits the disconnection rating of the switch according to the prior art.

In contrast, in all the switches according to the invention as represented by the equivalent circuits shown in FIGS. 2 to 6, the current to be disconnected flows in the same sense in the arcs 21 and 22 which are formed during disconnection and which commutate onto the arc guide rails 17, 19 and 18, 20.

As can be seen, this is not achieved by the moving contacts 12 and 13 of the two contact systems 10 and 15 being arranged on a contact link, but by the moving contact 12 in the contact system 10 being electrically conductively connected to the stationary contact 14 in the contact system 15. Alternatively, a corresponding connection can also exist between the moving contact 13 and the stationary contact 11. In any case, this connection has the intermediate conductor section 26 which can be seen in FIGS. 2 to 6.

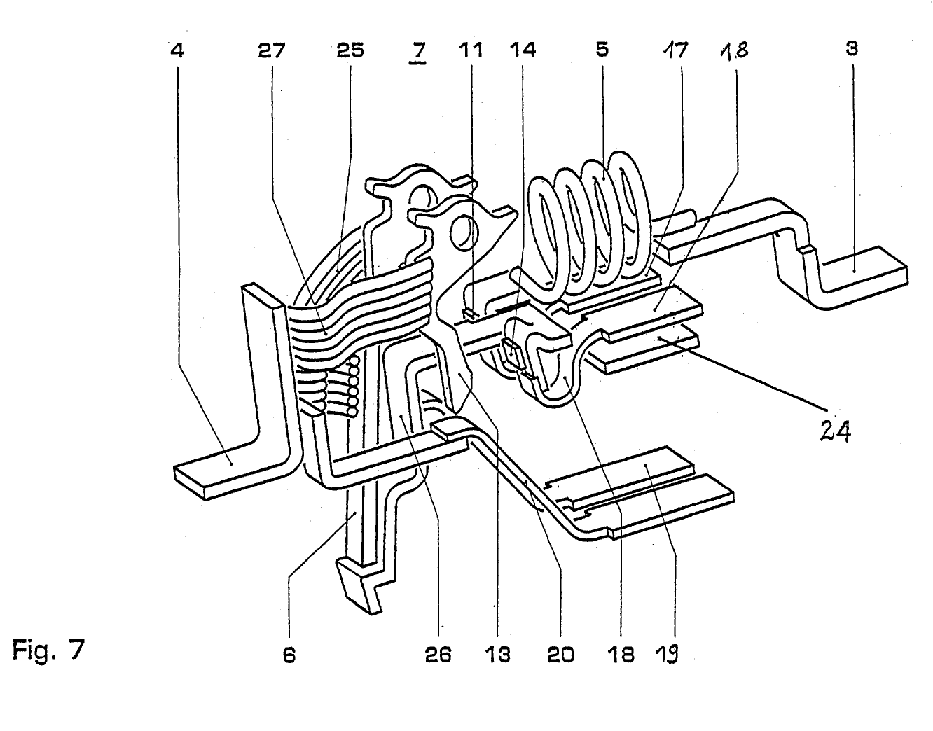

As can be seen from the design configuration, as illustrated in FIG. 7, of the current path 7 of the switch according to the invention as represented by the equivalent circuit shown in FIG. 2, the majority of this intermediate conductor section 26 is arranged in the centre between the two contact systems 10, 15, and is designed such that it is angled. A contact support, which is at right angles to the angle, is integrally formed for the stationary contact 14 at the free end of one limb of the angle, which is not shown for reasons of clarity. The other limb of the angle, which points downwards, is fitted at its lower end with the overcurrent release 6, which is in the form of a bimetallic strip. This bimetallic strip points upwards parallel to the abovementioned limb in a space-saving manner, and is connected at its upper end to the electrical conductor section 25 which is in the form of a braid, that is to say it is flexible. The intermediate conductor section 26 in the switch shown in FIG. 4 is also designed and arranged in a corresponding manner.

As a modification to this configuration, the one limb of the angle may also be connected via the flexible electrical conductor section 27 to the moving contact 13, and the other limb can be connected via the coil of the short-circuit current release 5 to the stationary contact 11. This embodiment is provided in the switches shown in FIGS. 3 and 5.

One refinement of the current path, which can be implemented particularly advantageously in terms of manufacture, is provided in the switch shown in FIG. 6. In this case, one limb of the angle is connected via the flexible electrical conductor section 25 to the moving contact 12, and the other limb is connected to the stationary contact 14.

Since the arcing chambers of both contact systems 10 and 15 are adjacent alongside one another not only in the switch according to the prior art but also in the switches designed according to the invention as shown in FIGS. 2 to 6, the arcs 21, 22, through which the disconnection current flows in the same sense, attract one another owing to the electrodynamic forces. If one of the two arcs, for example the arc 21, is somewhat weaker than the other, for example the arc 22, then the stronger arc 22 draws the weaker arc 21 with it, then accelerates its movement onto the arc guide rails 17, 19, and at the same time also improves the way in which it moves into the arc splitter stack 23. The disconnection capacity of the switch designed according to the invention is thus improved in comparison with a switch according to the prior art with comparable dimensions.

Since, in the embodiments of the switch according to the invention as shown in FIGS. 2 and 3, the overcurrent release 5 is connected in parallel with the isolation gap formed by the two arc guide rails 17, 19 and bridged by the arc 21 during disconnection, the overcurrent release 6, which is preferably in the form of a bimetallic element, is only briefly subjected to the influence of the current to be disconnected. The overcurrent release 6 can thus be designed to be relatively less strong.

If, in contrast and as shown in the embodiments in FIGS. 4 to 6, the overcurrent release 6 and the arc 21 burning in the isolation gap are connected in series, then the impedance of the overcurrent release 6 is added to the impedances of the arcs 21, 22, then assisting them in limiting the current. The switching capacity of the circuit breaker is thus additionally increased.

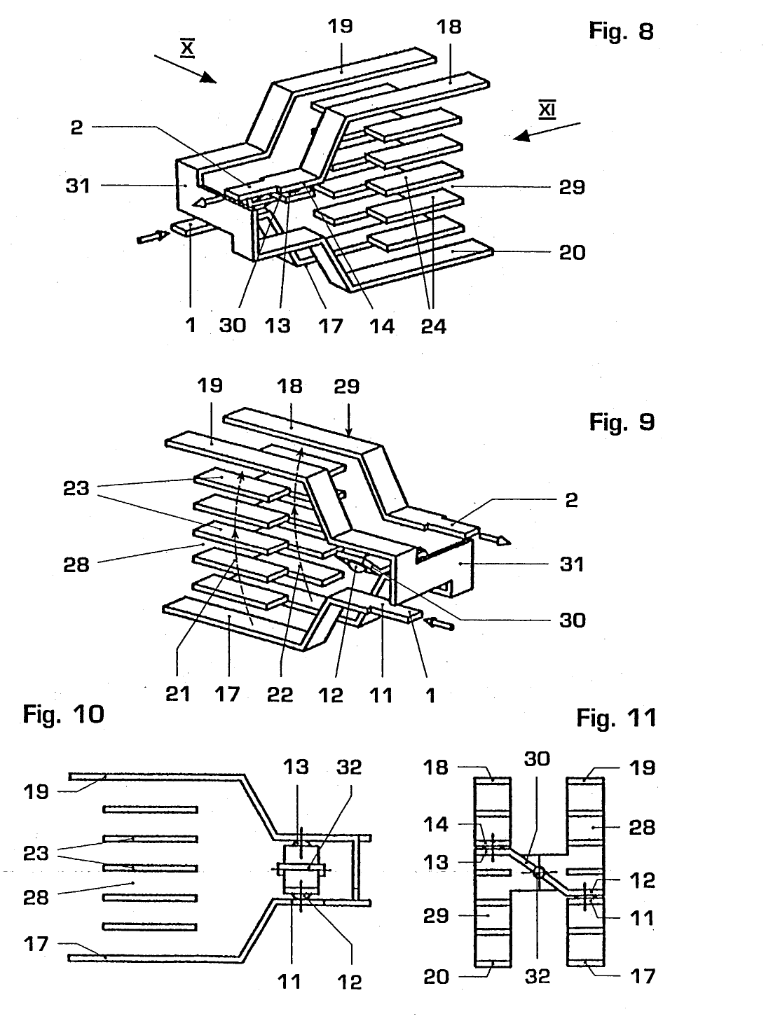

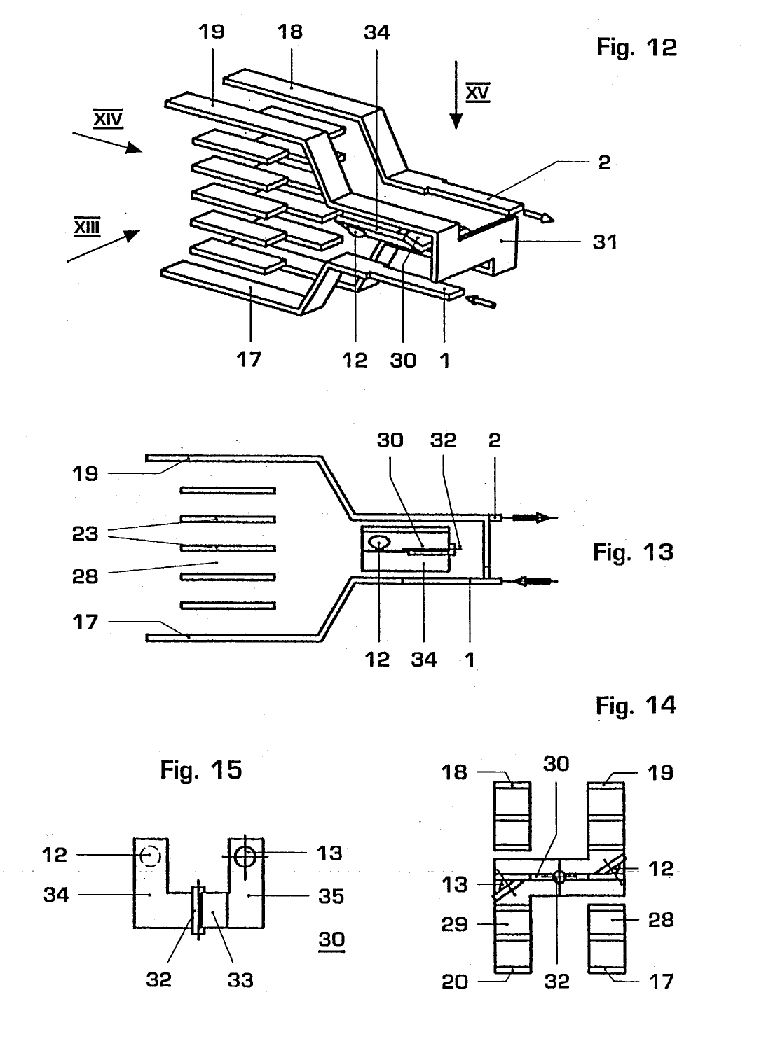

In the embodiments of the circuit breaker according to the invention and as shown in FIGS. 8 to 17, the moving contacts 12, 13 in the two contact systems are each arranged on one of the two arms of a contact link 30, which is in the form of a two-armed lever and can rotate. The two stationary contacts 11, 14 in the contact systems are electrically conductively arranged on the arc guide rails 17, 18 of the arcing chambers 28, 29 (see, for example, FIGS. 8 and 9, respectively). The geometries of the arcing chambers 28 and 29, respectively, which are governed by the respective stationary contacts 11 and 14 and the respective arc guide rails 17, 19 and 18, 20, in each case lie on the limbs of a U which are aligned parallel to one another, with the base of this U being formed by the contact link 30 (FIGS. 8 to 11 and 16 and 17), or by a section of the contact link 31 (FIGS. 12 to 15). The rotation axis 32 (for example FIGS. 10, 11 and 13 to 15, respectively) of the contact link 30 is thus aligned parallel to the limbs of the U. The arc guide rails 19 and 20 in the arcing chambers are electrically conductively connected to one another via a guide rail connection 31.

In the embodiment shown in FIGS. 8 to 11, when the contact arrangement (FIG. 8) is closed, the current flows in the direction of the arrow from the power connection 1 via the contact link 31, which makes contact with the stationary contacts 11, 14, to the power connection 2 (only the stationary contact 14 is shown in FIG. 8). If the switch is opened while carrying current, then two switching arcs 21 and 22 are formed, and are guided by electrodynamic forces from the respective contacts 11, 12 and 13, 14 onto the respective arc guide rails 17, 19 and 18, 20 (FIG. 9). The current is now commutated into a quenching circuit which includes the arcing chambers 28, 29, and flows from the power connection 1 via the arc guide rail 17, the switching arc 21, the arc guide rail 19, the guide rail connection 31, the guide rail 20, the switching arc 22 and the arc guide rail 18 to the power connection 2. Since the current is guided by means of the guide rail connection 31 from the upper arc guide rail 19 in the arcing chamber 28 onto the lower arc guide rail 20 in the arcing chamber 29, this means that the current direction in the two switching arcs 21 and 22 is the same. The two arcs thus attract one another and are driven synchronously by the electrodynamic forces into the arc splitter stacks 23, 24 of the two arcing chambers, and are quenched virtually at the same time.

The embodiment shown in FIGS. 8 to 11 is distinguished by particularly little wear. This is primarily due to the fact that the guide rail connection 31 is formed by a robust busbar which, in contrast to a flexible power connection—for example in the form of a braid—is subject to virtually no wear even after a large number of switching operations. At the same time, the busbar has a low electrical resistance. The switch according to the invention and developed in this way is thus distinguished not only by an excellent switching capacity and a long life, but also by minimal power losses and little heating.

In contrast to the embodiment shown in FIGS. 8 to 11, the contact link 30 in the embodiment shown in FIGS. 12 to 15 is designed like a U. As can be seen from FIG. 15, the rotation axis 32 of the contact link is located in the base 33 of the U while, in contrast, the two moving contacts 12 and 13 are respectively arranged at the free ends of the limbs 34 and 35 of the U. That section of the base 33 and of the limbs 34 which is arranged to the left of the rotation axis 32, and that section of the base 33 and of the limbs 35 which is arranged to the right of the rotation axis 32 each form a lever arm which is in the form of a right angle. This lever arm carries out the same functions as the corresponding lever arm in the embodiment shown in FIGS. 8 to 11. In addition, this angled lever arm is also distinguished by the following function: its section which is formed by the limb 34 is parallel with the power connection 1 (FIGS. 12 and 13). Thus, and because the U-shape of the contact link 30 means that the current flows in the opposite direction sense in the limb 34 to that in the power connection 1, the two electrical conductors 1 and 34 form a well-formed current loop. The electrical conductors 35 and 2 also produce a corresponding current loop. When the switch is opened, a particularly strong electrodynamic force then acts on the two switching arcs. The switching arcs are initially based on the disconnecting contacts and are quickly commutated by the strong electrodynamic force onto the arc guide rails 17 to 20. Since the current is flowing in the same direction sense in the two switching arcs, the two arcs attract one another, and both arcs are commutated virtually synchronously. The two switching arcs are thus driven virtually simultaneously and at the same time with a large amount of force into the arc splitter stacks 23, 24, and the current to be disconnected is interrupted by the quenching of the switching arcs. The switch is distinguished by having a high disconnection capacity owing to the synchronous commutation, supported by large forces, of the arcs from the contacts onto the arc guide rails.

Depending on the space requirement and the requirement for the switch, it is advantageous to route the guide rail connection 31 around the contact link 30 or around the arc splitter stacks 23, 24 of the two arcing chambers 28, 29. In the embodiments shown in FIGS. 8 to 16, the guide rail connection is routed, as can be seen, around the contact link while, in the embodiment shown in FIG. 17, it is routed around the arc splitter stack.

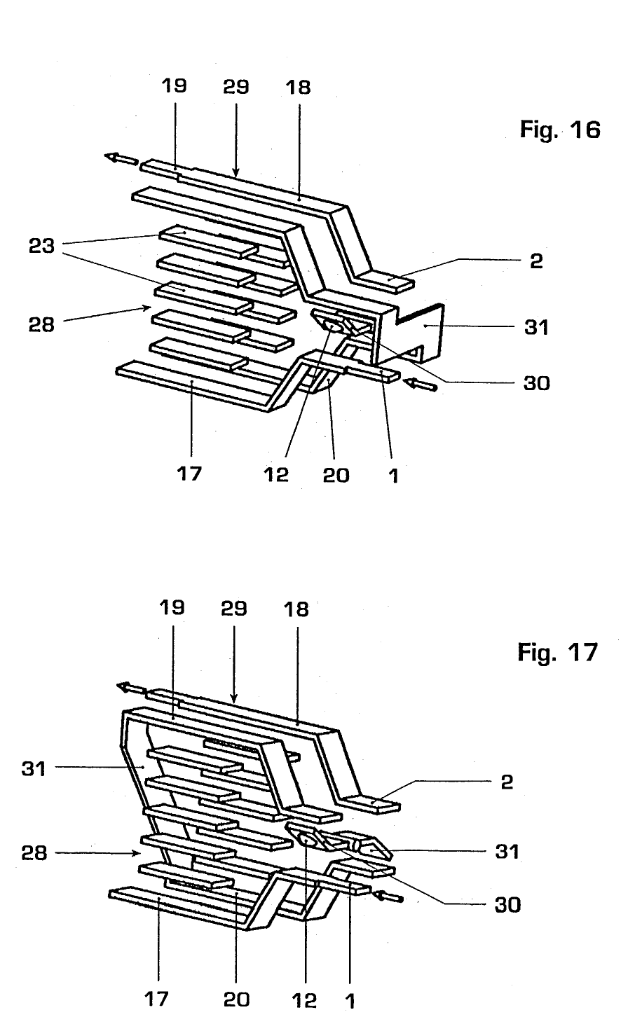

Depending on the form of the switch, the power connections 1, 2 may be connected to ends of the two arc guide rails 17, 18, on which the stationary contacts are arranged. This is done in the embodiments shown in FIGS. 8 to 15. In the embodiments shown in FIGS. 16 and 17, the power connection 2 is, in contrast, connected to one end of the arc guide rail 20, which engages over the arc splitter stack of the associated arcing chamber 29.

LIST OF REFERENCE SYMBOLS

| | |
|---|---|
| 1, 2 | Power connections |
| 3, 4 | Electrical conductor sections |
| 5 | Short-circuit current release |
| 6 | Overcurrent release |
| 7 | Current path |
| 10, 15 | Contact systems |
| 11, 14 | Stationary contacts |
| 12, 13 | Moving contacts |
| 17, 18, 19, 20 | Arc guide rails |
| 21, 22 | Arcs |
| 23, 24 | Arc splitter stacks |
| 25, 27 | Flexible electrical conductor |
| | sections |
| 26 | Intermediate conductor section |
| 28, 29 | Arcing chambers |
| 30 | Contact link |
| 31 | Guide rail connection |
| 32 | Rotation axis |
| 33 | Base of a U |
| 34, 35 | Limbs of the U |

1. Circuit breaker having a current path (7) which contains two power connections (1, 2) and a double-interrupting contact arrangement and in which the contact arrangement contains two contact systems (10, 15) which are connected in series in the current path (7) and have a stationary contact (11, 14) and a moving contact (12, 13), in which contact systems (10, 15) the current path has two sections which are routed in parallel with one another and are each formed by a switching arc (21, 22) during a switching process, characterized in that the contacts of the two contact systems are connected to one another and to the two power connections such that the current has the same direction sense in both sections.

2. Circuit breaker according to claim 1, in which the contact systems each have one of two arcing chambers (28, 29) which are arranged side by side with respect to one another, characterized in that the moving contacts (12, 13) of the two contact systems are each arranged on one of the two arms of a contact link (30) which is in the form of a two-armed lever and can rotate, in that the two stationary contacts (11, 14) of the contact systems are each arranged electrically conductively on a first (17, 18) of two arc guide rails (17, 19; 18, 20) of the arcing chambers (28, 29), and in that the two second arc guide rails (19, 20) of the two arcing chambers are electrically conductively connected to one another via a guide rail connection (31):

3. Circuit breaker according to claim 2, characterized in that the contact link (30) is in the form of a U, in that the rotation axis (32) of the contact link is located in the base (33) of the U, in that the two moving contacts (12, 13) are arranged at the free ends of the limbs (34, 35) of the U, and in that a section (1, 2) of the current path through which the current flows in the opposite sense is provided parallel to each of the two limbs.

4. Circuit breaker according to one of claims 2 or 3, characterized in that the guide rail connection (31) is routed around the contact link (30).

5. Circuit breaker according to one of claims 2 or 3, characterized in that the guide rail connection (31) is routed around arc splitter stacks (23, 24) of the two arcing chambers (28, 29).

6. Circuit breaker according to one of claims 2 to 5, characterized in that the two power connections (1, 2) are connected to ends of the two first arc guide rails (17, 18) at which the stationary contacts (11, 14) are arranged.

7. Circuit breaker according to one of claims 2 to 5, characterized in that one (2) of the two power connections (1, 2) is connected to one end of one (18) of the two first arc guide rails (17, 18), which engages over an arc splitter stack (24) of one (29) of the two arcing chambers (28, 29).

8. Circuit breaker according to claim 1, characterized in that the current path (7) contains an intermediate conductor section (26), which is connected in the current path between a moving contact (12, 13) of a first of the two contact systems (10, 15) and a stationary contact (11, 14) of the second contact system.

9. Circuit breaker according to claim 8, characterized in that the intermediate conductor section (26) is firstly electrically conductively rigidly connected to a contact support of the stationary contact (14), and is secondly electrically conductively connected to a first current sensor (5, 6) of a tripping apparatus which acts on the contact arrangement.

10. Circuit breaker according to claim 9, in which the contact systems each have one of two arcing chambers, which are arranged side by side alongside one another, and have the two arc guide rails (17, 19; 18, 20), which are connected to the two contacts (11, 12; 13, 14) and interact with an arc splitter stack (23, 24) of the arcing chamber (28, 29) which is associated with the contacts, characterized in that the first current sensor (6) is connected in parallel with an isolation gap which is formed by the two arc guide rails (17, 19; 18, 20) of one of the two contact systems (10, 15).

11. Circuit breaker according to claim 10, characterized in that a second current sensor (5) is connected in the current path (7) in parallel with the isolation gap and in series with the first current sensor (6).

12. Circuit breaker according to claim 8, characterized in that the intermediate conductor section (26) is electrically conductively connected firstly via a flexible conductor section (27) to a contact support of the moving contact (13), and secondly to a first current sensor (5, 6) of a tripping apparatus which acts on the contact arrangement.

13. Circuit breaker according to claim 12, having two arc guide rails (17, 19; 18, 20) which are connected to the two contacts (11, 12; 13, 14) and interact with an arc splitter stack (23, 24) of the arcing chambers (28, 29) which are associated with the contacts, characterized in that the first current sensor (5, 6) is connected in the current path (7) in series with an isolation gap which is formed by the two arc guide rails (17, 19) of one (10) of the two contact systems (10, 15).

14. Circuit breaker according to claim 13, characterized in that a second current sensor (6) is connected in parallel with the isolation gap.

15. Circuit breaker according to claim 13, characterized in that a second current sensor (5, 6) is connected in the current path (7) in series with the first current sensor (5, 6).

16. Circuit breaker according to claim 8, characterized in that the intermediate conductor section (26) is electrically conductively connected firstly via a flexible conductor section (25) to a contact support of the moving contact (12) and, secondly, is electrically conductively rigidly connected to a contact support of the stationary contact (14).

17. Circuit breaker according to claim 16, characterized in that a first current sensor (6) is connected in the current path between a first (1) of the two power connections (1, 2) and the stationary contact (11) of the second contact system (10), and a second current sensor (5) is connected in the current path between the second power connection (2) and the moving contact (13) of the first contact system (15).

18. Circuit breaker according to one of claims 8 to 17, characterized in that the majority of the intermediate conductor section (26) is arranged between the two contact systems (10, 15).

19. Circuit breaker according to one of claims 8 to 18, characterized in that the intermediate conductor section (26) is designed such that it is angled.
